(19) United States
(12) Patent Application Publication
(10) Pub. No.: US 2026/0081778 A1
(43) Pub. Date: Mar. 19, 2026

(54) LATTICE-BASED PUBLIC KEY CRYPTOSYSTEM SHARING A PART OF PUBLIC KEYS IN COMMON, AND SERVER INCLUDED THEREIN

(71) Applicant: INSTITUTE FOR BASIC SCIENCE, Daejeon (KR)

(72) Inventor: Kyungah SHIM, Daejeon (KR)

(73) Assignee: INSTITUTE FOR BASIC SCIENCE, Daejeon (KR)

(21) Appl. No.: 19/400,572

(22) Filed: Nov. 25, 2025

(30) Foreign Application Priority Data
Sep. 12, 2025 (KR) 10-2025-0130508

(51) Int. Cl. H04L 9/30; H04L 9/08

(52) U.S. Cl. CPC H04L 9/3093; H04L 9/0825

(57) ABSTRACT

A server for managing terminals that perform lattice-based public key cryptographic communication according to embodiments of the present disclosure is disclosed. Each of the terminals performs public key cryptographic communication based on a public key including a domain public key and an individual public key, and a randomly determined individual private key, wherein the individual public key is calculated according to the following mathematical formula: IP=f(CP,SK) (wherein IP is an individual public key, SK is an individual private key, CP is a domain public key, and f is an individual public key generation function), and wherein the server includes a communication circuit, a memory configured to store a program including instructions, and a processor that controls the server to perform a plurality of operations by executing the program stored in the memory.

### TECHNICAL FIELD

Embodiments of the present disclosure relate to a public key cryptosystem and a server, and more particularly, to a lattice-based public key cryptosystem sharing a part of public keys in common, and a server.

### BACKGROUND ART

Many modern cryptosystems are based on public key cryptography. Public key cryptosystems are widely used in various environments, such as electronic signatures, authentication, and key distribution. In public key cryptosystems, a public key is paired with a private key. The key owner securely stores the private key and distributes the public key so that anyone can access it. However, as the demand for security level increases, the length of public keys becomes longer, resulting in a problem that time and cost for transmitting and storing public keys increase significantly.

Lattice-based public key cryptosystems are attracting attention as an approach to addressing this problem. The lattice-based public key cryptosystems are based on a lattice structure, which is an algebraic structure, and the public key includes a randomly generated matrix (commonly referred to as a random matrix). Conventionally, the random matrix is individually generated for each terminal (entity) and included in the public key. In order to improve transmission efficiency, a method of transmitting a value (i.e., a seed) capable of generating the random matrix instead of directly transmitting the entire random matrix has also been proposed. In this method, there is an advantage that the amount of transmission can be reduced, but there is a limit in that each terminal has to generate a random matrix again from the received seed, and thus a computational burden is added.

### SUMMARY OF DISCLOSURE

### Technical Problem

An object to be achieved by the present disclosure is to provide a lattice-based public key cryptosystem that enables efficient cryptographic communication by setting a part of public keys in common among terminals within a specific group (domain) in the lattice-based public key cryptosystem, and a server.

### Solution to Problem

According to embodiments of the present disclosure, there is provided a server for managing terminals performing lattice-based public key cryptographic communication, wherein each of the terminals performs public key cryptographic communication based on a public key including a domain public key and an individual public key, and a randomly determined private key, wherein the individual public key is calculated according to the following mathematical formula: IP=f(CP,SK) (wherein IP is an individual public key, SK is an individual private key, CP is a domain public key, and f is an individual public key generation function), and wherein the server includes a communication circuit, a memory configured to store a program including instructions, and a processor that controls the server to perform a plurality of operations by executing the program stored in the memory, wherein the plurality of operations include the steps of: randomly generating and providing a domain public key of a first terminal among the terminals, and determining and providing a domain public key of a second terminal, which belongs to the same domain as that of the first terminal, among the terminals to be identical to the domain public key of the first terminal.

According to embodiments of the present disclosure, there is provided a public key cryptosystem including terminals performing public key cryptographic communication and a server, wherein each of the terminals performs public key cryptographic communication based on a public key including a domain public key and an individual public key, and a randomly determined individual private key, wherein the individual public key is calculated according to the following mathematical formula: IP=f(CP,SK) (wherein IP is an individual public key, SK is an individual private key, CP is a domain public key, and f is an individual public key generation function), and wherein the server randomly generates and provides a domain public key of a first terminal among the terminals, and determines and provides a domain public key of a second terminal, which belongs to the same domain as that of the first terminal, among the terminals to be identical to the domain public key of the first terminal, wherein the first terminal stores the domain public key of the first terminal provided by the server, and the second terminal stores the domain public key of the second terminal provided by the server.

### Advantageous Effects of Invention

Since a part of the public keys of the terminals of the public key cryptosystem according to embodiments of the present disclosure are common, the transmission of the common portion can be omitted when transmitting the public key between the terminals, thereby reducing the overall transmission amount.

Since a part of the public keys of the terminals of the public key cryptosystem according to embodiments of the present disclosure are common, the common portion of the public key itself can be distributed to each terminal in advance, and the computation required to restore the public key from the seed of the public key as in the related art can be omitted, thereby increasing efficiency.

### BRIEF DESCRIPTION OF DRAWINGS

In order to more fully understand the drawings cited in the detailed description of the present disclosure, a brief description of each drawing is provided.

FIG. 1 illustrates an authentication system according to embodiments of the present disclosure.

FIG. 2 illustrates a public key cryptosystem according to embodiments of the present disclosure.

FIG. 3 illustrates a public key cryptosystem according to embodiments of the present disclosure.

FIG. 4 is a diagram for describing an operation of a management server according to embodiments of the present disclosure.

FIGS. 5 and 6 are diagrams for describing an operation of a cryptosystem according to embodiments of the present disclosure.

FIG. 7 illustrates an electronic device according to embodiments of the present disclosure.

### DESCRIPTION OF EMBODIMENTS

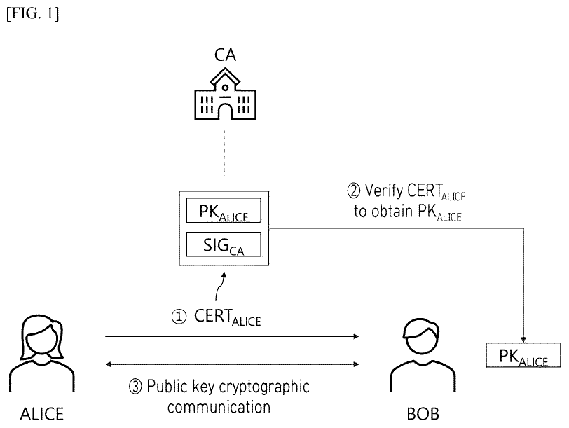

FIG. 1 illustrates an authentication system according to embodiments of the present disclosure. Referring to FIG. 1, the authentication system 10 may provide a certificate for a public key used in a public key cryptosystem, that is, a public key certificate issuance, management, and verification service.

According to embodiments, the public key certificate provided by the authentication system 10 may be used to verify the validity of the public key in various cryptosystems using the public key method. FIG. 1 is a diagram for explaining a public key cryptography to which embodiments of the present disclosure are applied. Referring to FIG. 1, a public key user (ALICE) and a counterpart (BOB) perform public key cryptographic communication based on a public key cryptography algorithm.

Basically, public key cryptographic communication presupposes that the counterpart (BOB) has the owner's (ALICE's) public key (PK_{ALICE}), and is characterized in that messages transmitted and received during communication are encrypted with the user's (ALICE's) public key (PK_{ALICE}). Public key cryptographic communication includes public key encryption and key encapsulation mechanism (KEM).

For example, in the case of public key encryption, a message (plaintext) desired by the counterpart (BOB) is encrypted with the public key (PK_{ALICE}) of the user (ALICE), and the encrypted message is transmitted to the user (ALICE). The user (ALICE) decrypts the encrypted message with a private key corresponding to his/her own public key (PK_{ALICE}) to obtain the message.

In addition, for example, in the case of the key encapsulation mechanism, the counterpart (BOB) generates an arbitrary session key (symmetric key) for communication with the user (ALICE), encrypts the session key with the user's (ALICE's) public key (PK_{ALICE}), and transmits it. The user (ALICE) receives the encrypted session key and decrypts it with a private key corresponding to his/her own public key (PK_{ALICE}) to obtain the session key, and communicates with the counterpart (BOB).

In any case, the process of encrypting with the user's public key (PK_{ALICE}) is involved, and thus the public key (PK_{ALICE}) must be safely delivered to the counterpart (BOB). That is, the public key (PK_{ALICE}) obtained by the counterpart (BOB) must be a valid public key of the actual user (ALICE). To this end, there is a public key certificate. The public key certificate is data for proving that a specific public key is a ‘valid’ public key of the ‘user’.

For example, the public key certificate may be used to verify the validity of public keys in various cryptosystems using the public key method. For example, the public key certificate may be used to verify the validity of public keys used in cryptosystems for electronic signatures, key encapsulation mechanisms, key distribution, key agreement, aggregate signatures, homomorphic encryption, functional encryption, and functional signature.

Referring back to FIG. 1, a user (ALICE) issues and receives a user certificate (CERT_{ALICE}) for his/her public key (PK_{ALICE}) and delivers it to the counterpart (BOB). In this case, the user certificate (CERT_{ALICE}) may be issued from a certain certificate authority (CA). Here, the user certificate (CERT_{ALICE}) is used to authenticate that the public key (PK_{ALICE}) of the user (ALICE) is the public key of the actual user (ALICE).

The certificate authority (CA) receives the public key (PK_{ALICE}) from the user (ALICE) and generates a user certificate (CERT_{ALICE}) including the public key (PK_{ALICE}) and the electronic signature (SIG_{CA}) of the certificate authority (CA) for the public key (PK_{ALICE}). According to embodiments, the user certificate (CERT_{ALICE}) may further include identification information for identifying the user (ALICE).

The counterpart (BOB) receives the user certificate (CERT_{ALICE}) of the user (ALICE) and verifies the user certificate (CERT_{ALICE}) to obtain the user public key (PK_{ALICE}). In this case, the counterpart (BOB) obtains the user public key (PK_{ALICE}) by verifying the electronic signature (SIG_{CA}) of the certificate authority (CA) included in the user certificate (CERT_{ALICE}).

According to embodiments, the counterpart (BOB) verifies the electronic signature (SIG_{CA}) of the certificate authority (CA) included in the user certificate (CERT_{ALICE}) by using the previously stored public key of the certificate authority (CA).

When the user certificate (CERT_{ALICE}) of the user (ALICE) is verified, the counterpart (BOB) determines that the user public key (PK_{ALICE}) obtained from the user certificate (CERT_{ALICE}) is valid, and performs public key cryptographic communication with the user (ALICE) using the public key (PK_{ALICE}).

As such, for public key cryptographic communication, the user public key (PK ALICE) and/or user certificate (CERT_{ALICE}) must be received and stored by the counterpart (BOB). Specifically, the user public key (PK_{ALICE}) and/or user certificate (CERT ALICE) must be transmitted and stored to all communication partners of the user (ALICE).

Meanwhile, since the size of the user public key (PK_{ALICE}) and user certificate (CERT_{ALICE}) is based on the size of the user public key (PK_{ALICE}), when the size of the user public key (PK_{ALICE}) increases (the length increases) for the security of public key cryptographic communication, the size of the user certificate (CERT_{ALICE}) also increases, which causes a problem in that the transmission amount of the public key cryptosystem increases and the time required for signing and verification increases. In particular, this problem becomes more severe as the number of members (more precisely, the number of public key users (ALICE)) of the public key cryptosystem increases.

Accordingly, embodiments of the present disclosure propose a public key cryptosystem that can reduce the transmission amount of a public key cryptosystem while maintaining security by configuring a portion of the public keys of users who wish to perform public key cryptographic communication to be common while setting the entire public key used for public key cryptographic communication to be different.

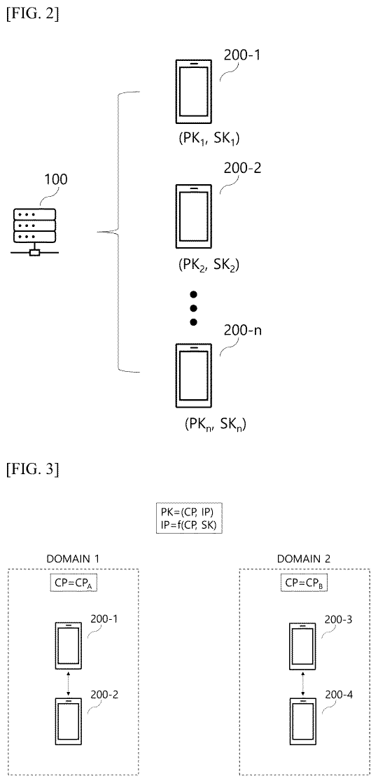

FIG. 2 illustrates a public key cryptosystem according to embodiments of the present disclosure. Referring to FIG. 2, the public key cryptosystem 10 includes a management server 100 and user terminals 200-1, 200-2, . . . , and 200-n (n is a natural number, collectively referred to as 200).

The devices 100 and 200 are electronic devices including an arithmetic processing unit and a communication circuit, and may be, for example, a server computer, a mobile terminal, a computer, etc., but are not limited thereto. For example, the devices 100 and 200 may store a program for performing an encryption operation and perform the encryption operation by loading the program. According to embodiments, the devices 100 and 200 may store an encryption program for performing an encryption operation according to a predetermined cryptographic scheme.

Here, the cryptographic scheme may be a lattice-based cryptographic scheme, but is not limited thereto. Alternatively, it may be a multivariable cryptographic scheme or a hash-based cryptographic scheme. For example, the cryptographic scheme may be Dilithium, Kyber, FrodoKEM, or SABER, but is not limited thereto.

That is, it can be understood that the operations of the devices 100 and 200 described in the present specification are performed according to the control of the cryptographic program installed in each of the devices 100 and 200. In other words, the operations of the devices 100 and 200 may correspond to the operations of the cryptographic program installed in each of them.

The management server 100 may issue a public key and/or a private key for public key cryptographic communication to each of the user terminals 200-1 to 200-n. For example, each of the user terminals 200-1 to 200-n may transmit a request for issuance of a public key and/or a private key to the management server 100, and the management server 100 may generate a public key and/or a private key for each of the user terminals 200-1 to 200-n and provide the generated public key and/or private key to the user terminals 200-1 to 200-n.

Meanwhile, in this specification, providing a public key and/or a private key includes not only directly transmitting the public key and/or private key to the corresponding entity, but also a series of actions that enable the corresponding entity to actually obtain the public key and/or private key, such as providing information (e.g., a link) that allows access to the public key and/or private key.

Additionally, the management server 100 may issue a certificate for each of the user terminals 200-1 to 200-n. For example, the management server 100 is a server of a certificate authority that authenticates user information of user terminals 200-1 to 200-n and may issue certificates for the public keys of the user terminals 200-1 to 200-n.

The user terminals 200 are electronic devices capable of performing public key cryptographic communication with other terminals. For example, the user terminals 200 may be mobile devices such as smartphones, vehicles, drones, cameras, etc., but are not limited thereto.

Each of the user terminal 200 may perform public key cryptographic communication with other terminals (i.e., counterparts) using its own (i.e., user's) public keys (PK₁, PK₂, . . . , PKₙ; collectively referred to as PK) and private keys (SK₁, SK₂, . . . , SKₙ; collectively referred to as SK).

In this specification, the public key of each user terminal 200 refers to the public key of the user of each user terminal 200. For example, the user of each user terminal 200 may store a public key issued as his/her identification information through a predetermined process in the user terminal 200, and perform public key cryptographic communication through the user terminal 200 based on the stored public key of the user. Hereinafter, the description will be made in this specification on the premise that the user terminal 200 performs public key cryptographic communication using the user's public key.

According to embodiments, the user terminals 200-1 to 200-n may perform lattice-based public key cryptographic communication. The lattice-based public key cryptographic communication is cryptographic communication based on mathematically hard problems defined in a lattice structure, which is an algebraic structure, such as the short integer solution (SIS) problem, the learning with errors (LWE) problem, or the learning with rounding (LWR) problem, and may be, for example, cryptographic communication using encryption techniques such as CRYSTALS-Dilithium, Falcon, CRYSTAL-Kyber, FrodoKEM, Saber, etc.

FIG. 3 illustrates a public key cryptosystem according to embodiments of the present disclosure. Referring to FIG. 3, user terminals 200-1, 200-2, 200-3, and 200-4 are illustrated. The user terminals 200-1 to 200-4 are examples of the user terminals 200-1 to 200-n described with reference to FIG. 2. That is, the description of the user terminals 200-1 to 200-4 described in FIG. 3 can also be applied to the user terminals 200-1 to 200-n of FIG. 2.

According to embodiments of the present disclosure, the user terminals 200-1 to 200-4 may be grouped and managed in a domain unit. In this case, cryptographic communication is performed between user terminals belonging to each domain. In FIG. 3, the first user terminal 200-1 and the second user terminal 200-2 belong to the first domain (DOMAIN 1), and the third user terminal 200-3 and the fourth user terminal 200-4 belong to the second domain (DOMAIN 2). In this case, cryptographic communication is performed between the first user terminal 200-1 and the second user terminal 200-2, and cryptographic communication is performed between the third user terminal 200-3 and the fourth user terminal 200-4.

In this specification, the term “domain” can be understood as a set collectively referring to user terminals capable of performing cryptographic communication with each other. According to embodiments of the present disclosure, by commonly setting a part of the public keys for terminals within the same domain, it is possible to achieve efficient cryptographic communication. According to embodiments, the domain is determined in advance, and the user terminals to be included in each domain may be determined based on the attributes of the user terminals 200-1 to 200-n (e.g., identification number, year of manufacture, etc.) or the attributes of the users of the terminals 200-1 to 200-n (e.g., residential area, gender, affiliated organization), but embodiments of the present disclosure are not limited thereto.

The user terminals 200-1 to 200-4 perform cryptographic communication using their public keys (PK) and private keys (SK). In this case, since the private keys (SK) are individually generated for each of the user terminals 200-1 to 200-4, they may also be referred to as individual private keys.

The public keys (PK) of the user terminals 200-1 to 200-4 include a domain public key (CP) and an individual public key (IP).

The domain public key (CP) may be a randomly generated matrix. For example, the domain public key (CP) may be a randomly selected matrix on the corresponding lattice structure.

The individual public key (IP) is determined based on the domain public key (CP) and the private key (SK). For example, the individual public key (IP) may be defined according to Mathematical Equation 1 below:

$$IP = f ( CP , SK ) \qquad [ Mathematical Equation l ]$$

wherein IP is an individual public key of each user terminal, SK is a private key of each user terminal, CP is a domain public key of each user terminal, and f is an individual public key generation function.

Meanwhile, according to embodiments of the present disclosure, the domain public key (CP) may be determined identically (i.e., commonly) for user terminals within the same domain. That is, user terminals within the same domain store and use the same domain public key (CP). That is, all user terminals corresponding to a specific domain commonly store the same domain public key (CP). In this respect, the domain public key (CP) may also be referred to as a common domain public key.

According to embodiments, the management server 100 may determine the same domain public key for user terminals belonging to the same domain. For example, the management server 100 may determine and provide the domain public key of a first user terminal 200-1 and the domain public key of a second user terminal 200-2 to be the same value (e.g., CPA). On the other hand, the management server 100 may determine different domain public keys for user terminals belonging to different domains. For example, the management server 100 may determine and provide the domain public keys (e.g., CPA) of the user terminals 200-1 and 200-2 belonging to the first domain (DOMAIN 1) and the domain public keys (e.g., CPB) of the user terminals 200-3 belonging to the second domain (DOMAIN 2) to be different from each other.

According to embodiments of the present disclosure, even if the same domain public key (CP) is determined for user terminals (e.g., 200-1 and 200-2) within the same domain, the overall public keys of the corresponding user terminals are determined to be different. This is because the individual public keys (IPs) of the corresponding user terminals are determined to be different. As described above, the individual public key (IP) of each user terminal is generated from the domain public key (CP) and the private key (SK), wherein the private key (SK) is randomly determined to be different for each user terminal, and thus, the individual public keys (IPs) are also determined to be different for each user terminal.

Consequently, even though the domain public key (CP) is common among the user terminals, since the individual public keys (IP) of each user terminal is set to be different, the public key (PK) itself, including the individual public key (IP) and the domain public key (CP), is determined to be different even among the user terminals belonging to the same domain, thereby maintaining the security of public key cryptographic communication.

For example, even in the case of FIG. 3, the domain public keys (CPs) of the first user terminal 200-1 and the second user terminal 200-2 belonging to the first domain (DOMAIN 1) are determined to be the same value (e.g., CPA). However, since the individual public keys (IPs) of each user terminal 200-1 and 200-2 are determined to be different, the overall public keys of the user terminals 200-1 and 200-2 are determined to be different.

The public key cryptosystem according to embodiments of the present disclosure has advantageous effects in two aspects.

First, the amount of transmission in the entire cryptosystem can be reduced. Since a part of the public keys (PKs) of the user terminals 200-1 and 200-2 within the same domain, i.e., the domain public keys (CPs), are set to be identical, it is sufficient to provide the domain public key (CP) to the user terminals 200-1 and 200-2 once for the first time for each domain. Thereafter, each of the user terminals 200-1 and 200-2 may store the initially provided domain public key and continuously utilize the stored public key. Therefore, during public key cryptographic communication between user terminals 200-1 and 200-2 within the same domain, there is no need to transmit the domain public key to each other, and only the individual public key needs to be transmitted, thereby reducing the transmission amount.

Second, the amount of computation in the entire cryptosystem can be reduced. In the conventional case, a seed for generating a public key to reduce the amount of transmission of the public key is transmitted without a domain public key (CP). However, since the public keys are different between the user terminals, the public key must be recalculated each time from the seed of each user terminal in order to verify the signature of each user terminal, so there is a problem of increasing the overall amount of computation. However, in the case of embodiments of the present disclosure, since the domain public keys (CPs) of the user terminals 200-1 and 200-2 within the same domain are common to each other, there is no need to individually receive or generate a domain public key (CP) for each user terminal each time, thereby reducing the amount of transmission.

According to embodiments, the domain public key (CP) of each user terminal 200-1 to 200-4 may be determined in advance prior to establishing cryptographic communication. For example, the management server 100 may arbitrarily generate in advance (e.g., determine using an arbitrary matrix) and store the domain public key (CP) prior to a key generation request of the user terminals 200-1 to 200-4. In this case, the management server 100 may generate in advance domain public keys for each domain to be managed and store a list of domain public keys. Thereafter, when a key generation request is received from the user terminals, the management server may determine the domain to which the corresponding user terminal belongs and then obtain and provide the domain public key corresponding to the determined domain from the stored list.

The domain public key (CP) may be provided in various forms. As described above, the domain public key (CP) may be generated by the management server 100 and transmitted directly to each of the user terminals 200-1 to 200-4 by the management server 100, or may be stored in a predetermined external database accessible by the management server 100, and then the user terminals 200-1 to 200-4 may access the database and obtain the CP.

Alternatively, the domain public key (CP) may be provided to and stored in the user terminals 200-1 to 200-4 in advance. For example, the domain public key (CP) may be pre-installed in the user terminals 200-1 to 200-4 when manufacturing, shipping, or selling (delivering to the consumer) the user terminals 200-1 to 200-4.

Alternatively, it may be included in the certificate of the certificate authority that manages the public key certificates of the user terminals 200-1 to 200-4. For example, the domain public key (CP) may be included in the certificate of the root certificate authority (i.e., the root certificate) that manages the certificates of the user terminals 200-1 to 200-4 and stored in advance within the user terminals 200-1 to 200-4. In particular, since the certificate of the root certificate authority is typically stored in advance in the operating system or browser of the user terminals 200-1 to 200-4, when the domain public key (CP) is included in the root certificate authority certificate, there is an effect that it can be transmitted in advance before the start of cryptographic communication of each of the user terminals 200-1 to 200-4.

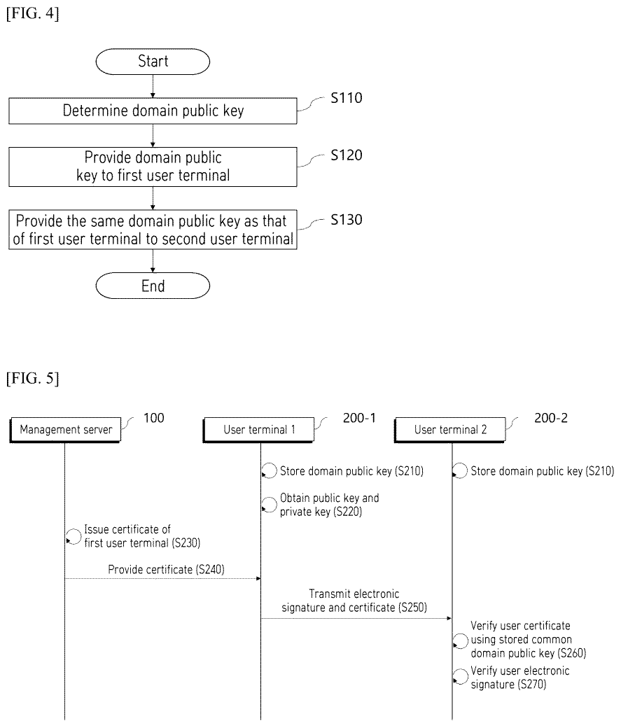

FIG. 4 is a diagram for describing the operation of the management server according to embodiments of the present disclosure. It is assumed that the user terminals 200-1 and 200-2 are included in the same domain.

Referring to FIG. 4, the management server 100 determines a domain public key (CP) (S110). According to embodiments, the management server 100 may predetermine a domain public key for a predetermined domain, or may determine a domain public key for a first user terminal 200-1 and determine this as the domain public key for the corresponding domain. In this case, the domain public key (CP) may be a randomly determined matrix.

The management server 100 provides a domain public key to the first user terminal 200-1 (S120). According to embodiments, the management server 100 may determine the domain to which the first user terminal 200-1 belongs and provide the domain public key corresponding to the determined domain to the first user terminal 200-1, but is not limited thereto.

Furthermore, providing the domain public key includes not only directly providing the domain public key but also providing a seed for generating the domain public key.

Thereafter, the management server 100 provides the same domain public key as the domain public key of the first user terminal 200-1 for a second user terminal 200-2 belonging to the same domain as that of the first user terminal 200-1 (S130). According to embodiments, the management server 100 may determine, based on the information of the second user terminal 200-2, whether the second user terminal 200-2 belongs to the same domain as that of the first user terminal 200-1.

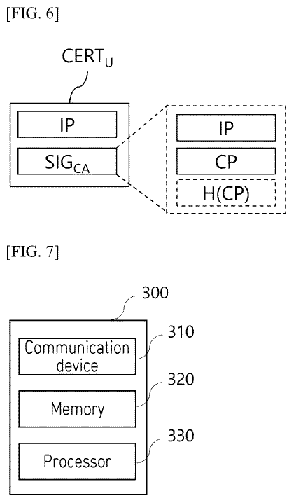

FIGS. 5 and 6 are diagrams for describing an operation of a cryptosystem according to embodiments of the present disclosure. It is assumed that the user terminals 200-1 and 200-2 are included in the same domain, and that the same domain public key has been provided in advance for each of the user terminals 200-1 and 200-2 (e.g., according to FIG. 4).

Referring to FIG. 5, the user terminals 200-1 and 200-2 store the domain public key (i.e., the common domain public key) generated by the management server 100 (S210).

The first user terminal 200-1 obtains a public key and a private key to be used for public key cryptographic communication (S220). According to embodiments, the first user terminal 200-1 may request the management server 100 to generate a key pair and receive a private key and an individual public key from the management server 100. Alternatively, the first user terminal 200-1 may obtain the key pair by generating a private key by itself and generating an individual public key using the private key and the domain public key.

The management server 100 issues a certificate of the first user terminal 200-1 (S230). The certificate of the first user terminal 200-1 may be a public key certificate for verifying the validity of the public key of the first user terminal 200-1.

According to embodiments, the management server 100 may issue a certificate of the first user terminal 200-1 according to the form of the certificate (CERT_{U}) illustrated in FIG. 6.

The certificate (CERT_{U}) of a user terminal (i.e., a signature terminal) that intends to perform an electronic signature includes an individual public key (IP) and an electronic signature (SIG_{CA}) of the certificate authority (i.e., the management server 100). Here, the electronic signature (SIG_{CA}) may be an electronic signature of the certificate authority for the individual public key (IP) and the domain public key (CP). For example, the electronic signature (SIG_{CA}) may be a value obtained by encrypting data including the individual public key (IP) and the domain public key (CP) with the private key of the corresponding certificate authority, or a value obtained by encrypting a hash value of data including the individual public key (IP) and the domain public key (CP) with the private key of the certificate authority, but is not limited thereto.

According to embodiments, the electronic signature (SIG_{CA}) included in the certificate (CERT_{U}) of the user terminal may be an electronic signature for the individual public key (IP), the domain public key (CP), and the hash value (H (CP)) of the domain public key (CP) of the corresponding user terminal.

Unlike the conventional art, the certificate (CERT_{U}) of the user terminal according to embodiments of the present disclosure includes only individual public keys (IPs), not the entire public key. This is because the verification terminal belongs to the same domain and thus pre-stores the domain public key (CP). The verification terminal compares the domain public key (CP) stored therein and the individual public key (IP) included in the certificate (CERT_{U}) with the electronic signature (SIG_{CA}). Accordingly, there is an effect that the size of the certificate (CERT_{U}) can be reduced.

In addition, according to embodiments, when the electronic signature (SIG_{CA}) included in the certificate (CERT_{U}) is verified, the hash value (H(CP) of the domain public key (CP) can be obtained. Therefore, the verification terminal may compare the hash value of the pre-stored domain public key (CP) with the hash value (H(CP)) of the domain public key (CP) obtained from the electronic signature (SIG_{CA}) to determine whether the verification terminal and the signature terminal belong to the same domain (i.e., whether they are permitted to communicate with each other). Accordingly, there is an effect of increasing security.

The management server 100 provides the certificate of the first user terminal to the first user terminal 200-1 (S240).

The first user terminal 200-1 uses its public key to create an electronic signature for a predetermined message and transmits the electronic signature along with its certificate to the second user terminal 200-2 (S250).

The second user terminal 200-2 may verify the certificate of the first user terminal 200-1 using the stored domain public key (S260). According to embodiments, the second user terminal 200-2 may restore the electronic signature of the certificate authority included in the certificate of the first user terminal 200-1 to obtain the user's public key (domain public key and individual public key), and compare the obtained public key with the stored domain public key and the individual public key included in the user certificate to verify the certificate.

Additionally, the second user terminal 200-2 may compare the hash value of the domain public key stored therein with the hash value of the domain public key obtained from the electronic signature of the certificate authority included in the certificate of the first user terminal 200-1, thereby determining whether the domain public key held by the second user terminal 200-2 and the domain public key held by the first user terminal 200-1 are identical. If the domain public key held by the second user terminal 200-2 and the domain public key held by the first user terminal 200-1 are not identical (i.e., the hash values are different), the second user terminal 200-2 may transmit a notification to the first user terminal 200-1 or the management server 100.

When the verification of the certificate of the first user terminal 200-1 is completed, the second user terminal 200-2 verifies the electronic signature using the public key of the first user terminal 200-1 (S270).

According to embodiments of the present disclosure, the second user terminal 200-2 may utilize the pre-stored domain public key in the process of verifying the certificate of the first user terminal 200-1, so that the amount of computation during verification can be significantly reduced. This effect can be enhanced as the number of user terminals within the domain increases.

FIG. 7 illustrates an electronic device according to embodiments of the present disclosure. The electronic device 300 of FIG. 7 may refer to the devices 100 and 200 described with reference to FIGS. 1 to 6.

The electronic device 300 may include a communication circuit 310, a memory 320, and a processor 330.

The communication circuit 310 may exchange data with an external device. According to embodiments, the communication circuit 310 may exchange data according to a wired or wireless communication protocol. For example, the communication circuit 310 may exchange information necessary for performing encryption operations, electronic signature operations, and key distribution operations performed by the electronic device 300. Furthermore, the communication circuit 310 may exchange data with an external server.

The memory 320 may store data necessary for the operation of the device 300. According to embodiments, the memory 320 may store a program including instructions for performing encryption operations, electronic signature operations, and/or key distribution operations. The device 300 may perform encryption operations, electronic signature operations, and/or key distribution operations by executing the program stored in the memory 320. For example, the memory 320 may store instructions (i.e., algorithms) for performing cryptographic schemes used during encryption operations.

The memory 320 may be volatile memory or non-volatile memory.

The processor 330 may control the overall operation of the device 300. According to embodiments, the processor 330 has an arithmetic processing function and can perform specific operations. For example, the processor 330 may execute a program stored in the memory 320 and, upon execution, perform encryption operations, electronic signature operations, and/or key distribution operations indicated by instructions included in the program.

For example, the processor 330 may be any one of a central processing unit (CPU), a microcontroller unit (MCU), a field programmable gate array (FPGA), an application specific integrated circuit (ASIC), and a graphical processing unit (GPU), but embodiments of the present disclosure are not limited thereto.

The operations of the device 300 according to embodiments of the present disclosure may be implemented in the form of a program stored in a computer-readable non-volatile storage medium.

The above description is merely an illustrative explanation of the technical idea of the present disclosure, and various modifications and variations can be made by those skilled in the art to which the present disclosure pertains without departing from the essential characteristics of the present disclosure. Accordingly, the embodiments disclosed in the present disclosure are not intended to limit but to explain the technical idea of the present disclosure, and the scope of the technical idea of the present disclosure is not limited by these embodiments. The scope of protection of the present disclosure should be interpreted by the claims below, and all technical ideas within the equivalent scope should be construed as being included in the scope of rights of the present disclosure.

Meanwhile, as used herein, when specific data is described as being transmitted, stored, or included, it means not only that the specific data is directly (i.e., the specific data itself) transmitted, stored or included, but also that data associated with the specific data (i.e., associated data), from which the specific data can be obtained as it is through a predetermined computational process, is transmitted, stored, or included. For example, as used herein, when specific data is said to be transmitted, stored, or included, it should be understood to encompass all of the following cases:
(1) the specific data itself is transmitted, stored, or included;
(2) the specific data after undergoing a predetermined transformation (e.g., encryption) is transmitted, stored, or included; and
(3) a value (e.g., seed or generator) for generating the specific data is transmitted, stored, or included.

The devices (units) described above may be implemented as hardware elements and/or software elements. For example, the hardware elements may include a microphone, an amplifier, a bandpass filter, an A/D converter, and a processing device. For example, the processing device may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or other devices capable of responding to instructions and executing instructions in a defined manner. The processing device may run an operating system (OS) and one or more software applications running on the operating system. In addition, the processing device may access, store, manipulate, process, and generate data in response to the execution of software. Although the processing device may be described as a single unit for simplicity of explanation, those skilled in the art will appreciate that the processing device may include a plurality of processing elements and/or a plurality of types of processing elements. For example, the processing device may include a plurality of processors, or a processor and a controller. Other processing configurations, such as parallel processors, are also possible.

The software may include computer programs, codes, instructions, or any combination thereof, which can independently or collectively configure or instruct the processing device to operate as desired. The software and data may be permanently or temporarily embodied in propagated signal waves that can be interpreted by the processing device or provide instructions or data to the processing device, or in various types of machines, components, physical devices, virtual equipment, computer storage media or devices, etc. The software may be distributed on network-connected computer systems, stored and executed in a distributed manner. The software and data may be stored on one or more computer-readable recording media, including data storage devices that store data and can be read by a computer system or processing device at a later time. The method according to the embodiment may be implemented in the form of program instructions that can be executed by various computer means and recorded on a computer-readable medium. Examples of computer-readable recording media include ROM, RAM, CD-ROM, magnetic tape, floppy disk, and optical data storage devices. They include magnetic media such as hard disks, floppy disks, and magnetic tape, optical media such as CD-ROMs and DVDs, magneto-optical media such as floptical disks, and hardware devices specifically configured to store and execute program instructions such as ROM, RAM, flash memory, and the like. In addition, functional programs, codes, and code segments that accomplish the examples disclosed herein can be easily understood and implemented by a programmer having ordinary skill in the art related to these examples based on or using the flowcharts and block diagrams of the drawings and the descriptions provided herein in connection therewith.

Although not universally applicable, the terminals or devices described herein may be applied to mobile devices such as cellular phones, PDAS, digital cameras, portable game consoles, MP3 players, portable/personal multimedia players (PMPs), portable e-books, portable laptop PCs, GPS navigation, tablets, and sensors, desktop PCs, HDTVs, optical disc players, set-top boxes, home appliances, and devices capable of wireless or network communication.

In addition, the computer-readable medium may include program instructions, data files, data structures, and the like alone or in combination. The program instructions recorded on the medium may be specially designed and configured for the embodiments or may be known and available to those skilled in the art of computer software. Examples of program instructions include not only machine language code such as that generated by a compiler, but also high-level language code that can be executed by a computer using an interpreter or the like. The hardware devices may be configured to operate as one or more software modules to perform the operations of the embodiments, and vice versa.

Although various embodiments have been described above, it should be understood that various modifications are possible. For example, appropriate results may be achieved even if the described techniques are performed in a different order, and/or elements of the described systems, structures, devices, circuits, etc. are combined in different ways or replaced or supplemented by other elements or equivalents. Accordingly, other implementations also fall within the scope of the following claims.

What is claimed is:

1. A server for managing terminals performing lattice-based public key cryptographic communication,
wherein each of the terminals performs public key cryptographic communication based on a public key including a domain public key and an individual public key, and a randomly determined individual private key,
wherein the individual public key is calculated according to the following mathematical formula:
$$IP = f ( CP , SK )$$
wherein IP is an individual public key, SK is an individual private key, CP is a domain public key, and f is an individual public key generation function, and
wherein the server comprises:
a communication circuit;
a memory configured to store a program including instructions; and
a processor that controls the server to perform a plurality of operations by executing the program stored in the memory,
wherein the plurality of operations comprise the steps of:
randomly generating and providing a domain public key of a first terminal among the terminals, and
determining and providing a domain public key of a second terminal, which belongs to the same domain as that of the first terminal, among the terminals to be identical to the domain public key of the first terminal.

2. The server of claim 1, wherein the plurality of operations further comprise the steps of:
for each of the terminals,
generating an individual private key;
generating an individual public key based on the domain public key and the individual private key; and
providing the individual private key and the individual public key.

3. The server of claim 1, wherein the plurality of operations further comprise:
a step of randomly generating and providing a domain public key of a third terminal, which belongs to a domain different from that of the first terminal, among the terminals to be different from the domain public key of the first terminal.

4. The server of claim 1, wherein the step of providing the domain public key of the first terminal comprises
directly transmitting the domain public key of the first terminal to the first terminal.

5. The server of claim 1, wherein the step of providing the domain public key of the first terminal comprises
transmitting, to the first terminal, information that allows access to the domain public key of the first terminal.

6. The server of claim 1, wherein the plurality of operations comprises a step of:
for each of the terminals,
generating a certificate of each terminal, wherein the certificate includes an electronic signature of the server for both the domain public key and the individual public key of each of the terminals, and the individual public key of each of the terminals.

7. The server of claim 6, wherein the electronic signature of the server included in the certificate of each of the terminals is an electronic signature for all of the domain public key, the individual public key, and the hash value of the domain public key of each of the terminals.

8. A public key cryptosystem comprising terminals performing public key cryptographic communication and a server,
wherein each of the terminals performs public key cryptographic communication based on a public key including a domain public key and an individual public key, and a randomly determined individual private key,
wherein the individual public key is calculated according to the following mathematical formula:
$$IP = f ( CP , SK )$$
wherein IP is an individual public key, SK is an individual private key, CP is a domain public key, and f is an individual public key generation function, and
wherein the server
randomly generates and provides a domain public key of a first terminal among the terminals, and
determines and provides a domain public key of a second terminal, which belongs to the same domain as that of the first terminal, among the terminals to be identical to the domain public key of the first terminal,
wherein the first terminal stores the domain public key of the first terminal provided by the server, and
the second terminal stores the domain public key of the second terminal provided by the server.

9. The public key cryptosystem of claim 8, wherein the server, for each of the terminals,
generates an individual private key,
generates an individual public key based on the domain public key and the individual private key, and
provides the individual private key and the individual public key.

10. The public key cryptosystem of claim 8, wherein the server
generates a certificate of the first terminal, wherein the certificate includes an electronic signature of the server for both the domain public key and the individual public key of the first terminal, and the individual public key of the first terminal.

11. The public key cryptosystem of claim 10, wherein the electronic signature of the server included in the certificate of the first terminal is an electronic signature for all of the domain public key, the individual public key, and the hash value of the domain public key of the first terminal.

12. The public key cryptosystem of claim 10, wherein the second terminal
receives the certificate of the first terminal, and
verifies the certificate of the first terminal by using the individual public key of the first terminal included in the certificate of the first terminal and the domain public key previously stored in the second terminal.

13. The public key cryptosystem of claim 10, wherein the first terminal
generates an electronic signature for a predetermined message by using the individual private key of the first terminal and the domain public key stored in the first terminal, and
transmits, to the second terminal, the electronic signature of the first terminal and a certificate for the public key of the first terminal.

14. The public key cryptosystem of claim 8, wherein the server
randomly generates and provides a domain public key of a third terminal, which belongs to a domain different from that of the first terminal, among the terminals to be different from the domain public key of the first terminal.
